(19) United States
(12) Patent Application Publication
(10) Pub. No.: US 2023/0129842 A1
(43) Pub. Date: Apr. 27, 2023

(54) QUESTIONNAIRE DATA ANALYSIS METHOD AND INFORMATION PROCESSING APPARATUS

(71) Applicant: FUJITSU LIMITED, Kawasaki-shi (JP)

(72) Inventors: Kazuhiro MATSUMOTO, Kawasaki (JP); Masatoshi OGAWA, Zama (JP); Hitoshi YANAMI, Kawasaki (JP); Noriyasu ASO, ISEHARA (JP); Hiromitsu SONEDA, Atsugi (JP); Katsumi HOMMA, Kawasaki (JP); Natsuki ISHIKAWA, Yamato (JP); Hayato Dan, Yokohama (JP)

(73) Assignee: FUJITSU LIMITED, Kawasaki-shi (JP)

(21) Appl. No.: 17/891,137

(22) Filed: Aug. 19, 2022

(30) Foreign Application Priority Data
Oct. 26, 2021 (JP) 2021-174678

(51) Int. Cl. G06Q 30/02

(52) U.S. Cl. CPC G06Q 30/0203

(57) ABSTRACT

A non-transitory computer-readable recording medium stores a program for causing a computer to execute a process, the process includes generating a plurality of causal relationship candidates each including a pair of a first answer candidate to each of at least some of first questions and a second answer candidate to one of second questions based on questionnaire result data, and searching for a solution of a combinatorial optimization problem that minimizes or maximizes a value of an objective function of which the value changes according to causal relationship candidates to be combined, under a constraint condition such that a predetermined ratio of respondents or more of the plurality of respondents have answers that are same as the pair of the first answer candidate and the second answer candidate of any one of the causal relationship candidates to be combined.

### CROSS-REFERENCE TO RELATED APPLICATION

This application is based upon and claims the benefit of priority of the prior Japanese Patent Application No. 2021-174678, filed on Oct. 26, 2021, the entire contents of which are incorporated herein by reference.

### FIELD

The embodiments discussed herein are related to a questionnaire data analysis method and an information processing apparatus.

### BACKGROUND

In order to recognize a general tendency of behaviors of people having various attributes, questionnaire surveys and data analysis using answers of questionnaire respondents to questions are widely conducted. For example, a large number of people are asked to answer a questionnaire regarding an attribute and a food waste behavior tendency of the person, and data analysis is performed on the answer result using a computer. This makes it possible to find a causal relationship regarding what kind of food waste behavior respondents having what kind of attribute have.

As a technique regarding the data analysis, a technique using decision tree analysis for ticket satisfaction analysis has been proposed. Furthermore, it has been proposed to use decision tree analysis to generate a classifier in a spread prediction system that predicts a time when a customer starts to use a product or a service for each customer. Furthermore, a technique has been proposed for using answer data to a plurality of questions regarding each project in a computer system that detects a sign of a risk in the project. Moreover, it has been proposed to use attribute data of a customer including customer questionnaire information in an information processing apparatus that extracts a variable that well describes a predicted value according to deep learning.

U.S. Patent Application Publication No. 2017/308903, Japanese Laid-open Patent Publication No. 2009-238193, Japanese Laid-open Patent Publication No. 2010-108404, and International Publication Pamphlet No. WO 2018/142753 are disclosed as related art.

### SUMMARY

According to an aspect of the embodiments, a non-transitory computer-readable recording medium stores a program for causing a computer to execute a process, the process includes generating a plurality of causal relationship candidates each including a pair of a first answer candidate to each of at least some of one or a plurality of first questions and a second answer candidate to one of one or a plurality of second questions based on questionnaire result data that indicates an answer of each of a plurality of respondents to a questionnaire that includes the one or the plurality of first questions regarding an attribute of a relevant respondent and the one or the plurality of second questions regarding a behavior of the relevant respondent, and searching for a solution of a combinatorial optimization problem that minimizes or maximizes a value of an objective function of which the value changes according to causal relationship candidates to be combined, under a constraint condition such that a predetermined ratio of respondents or more of the plurality of respondents have answers that are same as the pair of the first answer candidate and the second answer candidate of any one of the causal relationship candidates to be combined based on the questionnaire result data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a questionnaire data analysis method according to a first embodiment;

FIG. 2 is a diagram illustrating an example of hardware of a computer;

FIG. 3 is a diagram illustrating functions of a computer for data analysis;

FIG. 4 is a diagram illustrating an example of questionnaire result data;

FIG. 5 is a diagram illustrating an example of processing of a data analysis unit;

FIG. 6 is a diagram illustrating an example of analysis result data;

FIG. 7 is a flowchart illustrating an example of a procedure of data analysis processing;

FIG. 8 is a flowchart illustrating a first example of causal relationship candidate generation processing;

FIG. 9 is a diagram illustrating an example of a generated causal relationship candidate;

FIG. 10 is a flowchart illustrating a second example of the causal relationship candidate generation processing;

FIG. 11 is a diagram illustrating a generation example of a causal relationship candidate using decision tree analysis;

FIG. 12 is a flowchart illustrating an example of a procedure of combinatorial optimization processing that prioritizes a smaller number of causal relationships;

FIG. 13 is a diagram illustrating a procedure for determining a causal relationship candidate to be left in an analysis result of the combinatorial optimization processing that prioritizes the smaller number of causal relationships;

FIG. 14 is a flowchart illustrating an example of a procedure of combinatorial optimization processing that prioritizes accuracy of a causal relationship; and

FIG. 15 is a diagram illustrating a procedure for determining a causal relationship candidate to be left in an analysis result of the combinatorial optimization processing that prioritizes the accuracy of the causal relationship.

### DESCRIPTION OF EMBODIMENTS

When a causal relationship between an attribute and a behavior regarding a general tendency of a group of questionnaire respondents is analyzed using questionnaire survey results, for example, it is considered to group the respondents having similar attributes and perform analysis for each group. If each respondent belongs to any one of groups and a causal relationship between the attribute and the behavior of the respondent belonging to each group is found for each group, it is possible to recognize the causal relationship between the attribute and the behavior of all the respondents.

However, typically, it is not possible to perform grouping to properly explain the causal relationship between the attribute and the behavior of the respondent for the group of the respondents (whole or majority). Therefore, with related art, analysis is performed under inappropriate grouping, and it is difficult to correctly analyze the causal relationship between the attribute and the behavior of the questionnaire respondent.

Hereinafter, embodiments will be described with reference to the drawings. Note that each of the embodiments may be implemented in combination with a plurality of embodiments within a consistent range.

### First Embodiment

A first embodiment will be described. The first embodiment is a questionnaire data analysis method for generating a large number of candidates of a causal relationship between an attribute and a behavior of respondents to a questionnaire and searching for an optimal causal relationship combination using an objective function according to an object of analysis considering all the respondents. The object of the analysis is, for example, that a causal relationship between the attribute and the behavior of a respondent is accurately expressed as possible by candidates of the combined causal relationships, that the number of combinations of the causal relationship candidates is smaller as possible, or the like.

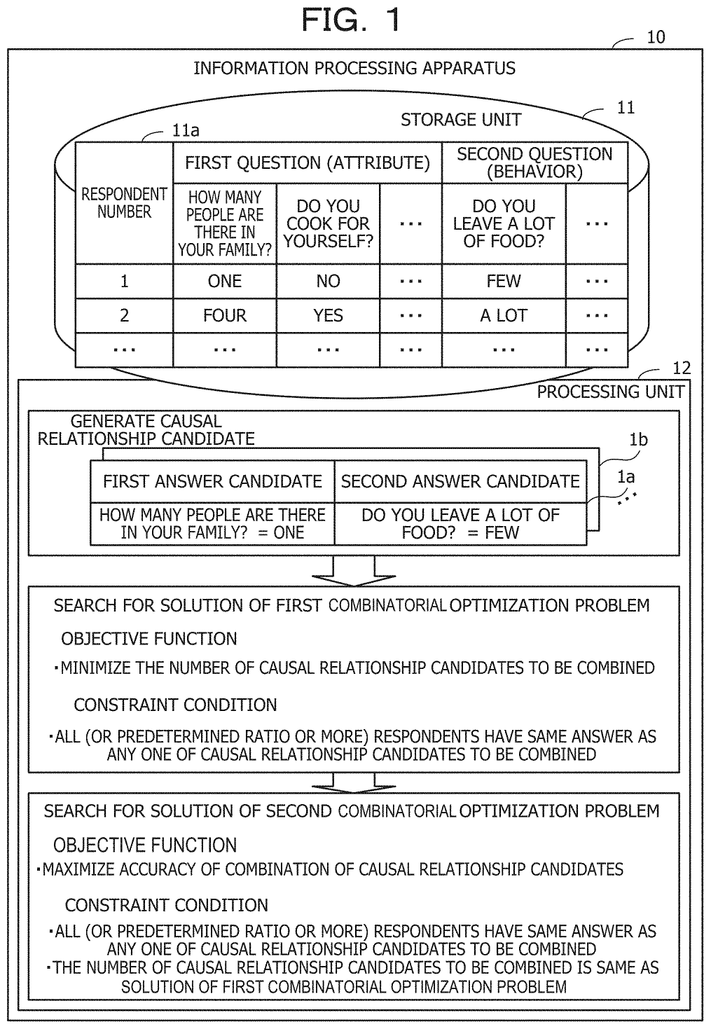

FIG. 1 is a diagram illustrating an example of the questionnaire data analysis method according to the first embodiment. In FIG. 1, an information processing apparatus 10 that executes the questionnaire data analysis method is illustrated. The information processing apparatus 10 may execute the questionnaire data analysis method, for example, by executing a questionnaire data analysis program.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores questionnaire result data 11a. The questionnaire result data 11a indicates an answer of each of a plurality of respondents to a questionnaire including one or a plurality of first questions regarding attributes of the respondents and one or a plurality of second questions regarding behaviors of the respondents. For example, in the questionnaire result data 11a, it is indicated that a respondent with a respondent number “1” has answered “one” to a question “How many people are there in your family?”, has answered “No” to a question “Do you cook for yourself?”, and has answered “few” to a question “Do you leave a lot of food?”.

The processing unit 12 performs data analysis on the questionnaire result data 11a and analyzes a causal relationship between the attribute and the behavior of a group of respondents. Here, difficulty in obtaining a causal relationship considering all the respondents will be described.

In the data analysis, a plurality of respondents whose answers are similar are grouped in the same group, for example, through cluster analysis. Then, description regarding the group generated through the cluster analysis (what kind of attribute the respondent group has) is analyzed through decision tree analysis. In the decision tree analysis, a decision tree that branches according to an answer to a question (attribute of respondent) is generated, and a node of the decision tree includes respondents who have the same answers up to the node. Because the respondent group belonging to the same node has a common attribute, it is possible to describe what kind of attribute the group has and what kind of behavior the group tend to perform using a group of respondents belonging to each node as an explanation target by referring to the decision tree.

For example, if food waste behaviors of a plurality of respondents belonging to one group are the same, there is a possibility that description of the group (attributes such as living alone or cooking for oneself) is a cause of the food waste behavior. For example, it is possible to recognize a causal relationship between the attribute of the respondent and the food waste behavior.

However, there is a case where grouping analyzed using the duster analysis does not match the group (explanation target) described with the decision tree analysis when data analysis is performed as combining the cluster analysis and decision tree analysis. For example, there is a case where a respondent group to be explained belonging to a node of the decision tree belongs to a different group in the duster analysis. When the group in the cluster analysis does not match the explanation target according to the decision tree analysis, it is not possible to use the result of the decision tree analysis as description of the group generated through the duster analysis.

Note that it is possible to match the grouping if the respondents are grouped into more detailed groups in the decision tree analysis. However, the decision tree analysis becomes too detailed, and a plurality of groups having different causal relationships is included in the group generated through the cluster analysis. Then, reliability as the causal relationship regarding the group generated through the duster analysis is lowered.

Furthermore, if only the duster analysis is used, it is possible to analyze a co-occurrence tendency regarding an answer to a question in a questionnaire for each group. However, the co-occurrence tendency does not necessarily have a causal relationship.

In this way, typically, there is a possibility that the grouping is inconsistent and a useful analysis result is not obtained. Contrary, if analysis is performed while maintaining consistency of grouping, it is possible to prevent to fail the analysis of the causal relationship due to lack of the consistency of the grouping. Therefore, the processing unit 12 generates a large number of causal relationship candidates (group of respondents described by that causal relationship) and obtains a combination of the causal relationship candidates that explain all the respondents. As a result, the analysis of the causal relationship and the grouping may be performed as integrated processing, and it is possible to prevent the consistency of the grouping from being lacked.

For example, the processing unit 12 generates a plurality of causal relationship candidates 1a, 1b, . . . on the basis of the questionnaire result data 11a. Each of the causal relationship candidates 1a, 1b, . . . includes a first answer candidate to each of first questions that is at least some of the one or the plurality of first questions and a second answer candidate to one of the one or the plurality of second questions. For example, the first answer candidate of the causal relationship candidate 1a is “How many people are there in your family?=one” and the second answer candidate is “Do you leave a lot of food?=few”.

Each of the causal relationship candidates 1a, 1b, . . . represents a candidate of a group including one or more respondents. For example, a set of respondents who have the same answer as a pair of the first answer candidate and the second answer candidate of each of the causal relationship candidates 1a, 1b, . . . is a group corresponding to the causal relationship. For example, to the candidate of the group corresponding to the causal relationship candidate 1a, a respondent who answers “one” to the question “How many people are there in your family?” and answers “few” to the question “Do you leave a lot of food?” belongs. A respondent belonging to a group corresponding to any one of the causal relationship candidates 1a, 1b, . . . may be called a respondent who is correctly explained by the causal relationship candidate.

Next, the processing unit 12 searches for a solution of a combinatorial optimization problem that minimizes or maximizes a value of an objective function of which the value changes according to the causal relationship candidates to be combined, on the basis of the questionnaire result data 11a. As a constraint condition of the combinatorial optimization problem at this time, a first constraint condition is used such that a predetermined ratio of or more respondents among the plurality of respondents have the same answers as the pair of the first answer candidate and the second answer candidate of any one of the causal relationship candidates to be combined. The first constraint condition means that the predetermined ratio of or more respondents among the plurality of respondents are correctly explained by any one of the causal relationship candidates to be combined. If the condition of the predetermined ratio of or more respondents is changed to all respondents, all the respondents are explained by the causal relationship candidates to be combined.

The solution of the combinatorial optimization problem obtained in this way indicates the causal relationship candidates to be combined. The first constraint condition ensures that the predetermined ratio of or more respondents among the plurality of respondents are correctly explained by a combination of causal relationship candidates indicated in the solution. Furthermore, each of the plurality of causal relationship candidates 1a, 1b, . . . corresponds to the group of the respondents that are correctly explained by the causal relationship candidate. For example, the causal relationship and the group are associated with each other in advance, and its consistency is maintained. Therefore, it is possible to correctly analyze the causal relationship between the attribute and the behavior of the questionnaire respondent.

The processing unit 12 uses an appropriate objective function according to an object of the analysis as an objective function of the combinatorial optimization problem. For example, in a case where an object is to identify causal relationships as few as possible that explain all the respondents, the processing unit 12 searches for a solution of a first combinatorial optimization problem that minimizes the number of causal relationship candidates to be combined. This makes it possible to obtain the causal relationships as few as possible that explain all of the plurality of respondents (or predetermined ratio or more).

Furthermore, there is a case where an object is to identify an accurate causal relationship as possible that explain all the respondents. In this case, for example, for each of the causal relationship candidates to be combined, the processing unit 12 searches for a solution of a second combinatorial optimization problem that maximizes accuracy of the causal relationship between the attribute indicated by the first answer candidate and the behavior indicated by the second answer candidate. This makes it possible to obtain the most accurate causal relationship that explains all of the plurality of respondents (or predetermined ratio or more).

Note that the processing unit 12 may search for the solutions of both of the first combinatorial optimization problem and the second combinatorial optimization problem. In this case, the processing unit 12 solves a combinatorial optimization problem corresponding to an object with higher importance first and solves another combinatorial optimization problem using the solution.

For example, in a case where to reduce the number of causal relationships obtained as the solution is more important, the processing unit 12 searches for the solution of the first combinatorial optimization problem first, and thereafter, searches for the solution of the second combinatorial optimization problem using the solution of the first combinatorial optimization problem. For example, as a constraint condition when the solution of the second combinatorial optimization problem is searched, the processing unit 12 uses a second constraint condition such that the number of causal relationship candidates to be combined is equal to the number of causal relationship candidates included in a combination obtained as the solution of the first combinatorial optimization problem, in addition to the first constraint condition. By adding the second constraint condition, when there is a plurality of combination patterns of minimum causal relationship candidates that explain all the respondents (or predetermined ratio or more), the most accurate combination pattern among the plurality of combination patterns is obtained as a solution.

Furthermore, in a case where to maximize accuracy of a causal relationship obtained as a solution is more important, the processing unit 12 searches for the solution of the second combinatorial optimization problem first, and thereafter, searches for the solution of the first combinatorial optimization problem using the solution of the second combinatorial optimization problem. For example, the processing unit 12 uses the first constraint condition and a third constraint condition as the constraint conditions to search for the solution of the first combinatorial optimization problem. The third constraint condition is a condition such that the accuracy of each of the causal relationship candidates to be combined is equal to accuracy of each causal relationship candidate included in a combination that is obtained as the solution of the second combinatorial optimization problem. The accuracy of the causal relationship candidate is accuracy in that the attribute and the behavior indicated by the causal relationship candidate have a causal relationship. By adding the third constraint condition, when there is a plurality of combination patterns of the most accurate causal relationship candidates that explain all the respondents (or predetermined ratio or more), a combination pattern obtained by combining the smallest number of causal relationship candidates among the plurality of combination patterns may be obtained as a solution.

Note that the search for the solution of the second combinatorial optimization problem is processing for obtaining the combination of the causal relationship candidates that maximizes the accuracy in that the attribute and the behavior indicated by each of the causal relationship candidates to be combined have a causal relationship. The accuracy of having a causal relationship may be expressed by a numerical value by the following calculation.

For example, the processing unit 12 counts the number of respondents that are not explained by the causal relationship candidate, for each of the causal relationship candidates to be combined. The number of respondents who are not explained by the causal relationship candidates is a subtraction value obtained by subtracting the number of second respondents whose answers are the same as the second answer candidate indicated by the causal relationship candidate among the first respondents from the number of first respondents whose answers are the same as the first answer candidate indicated by the causal relationship candidate. Then, the processing unit 12 assumes the total of the subtraction values (the number of respondents who are not explained by causal relationship candidates) of the respective causal relationship candidates to be combined as an index of the accuracy of having the causal relationship. In this case, minimizing the total value maximizes the accuracy of having the causal relationship.

In this way, by expressing the accuracy of the combination of the causal relationship candidates by the total number of the respondents who are not explained by the causal relationship candidates, the value added to the total value increases as the number of causal relationship candidates included in the solution is smaller, and the accuracy is lowered. Conversely, as the number of causal relationship candidates included in the solution is larger, the accuracy increases. Therefore, if such an accuracy calculation method is used, it is possible to prevent the number of causal relationship candidates included in the solution from being too small in the search for the solution of the second combinatorial optimization problem.

Note that, even if the generated causal relationship candidates 1a, 1b, . . . include a candidate having low accuracy, since the number of respondents who are explained by the causal relationship candidate is small, the candidate having low accuracy is hardly included in the solution of the first optimization problem. Therefore, the processing unit 12 may generate the causal relationship candidates 1a, 1b, . . . as many as possible, including those with low accuracy. However, the number of causal relationship candidates 1a, 1b, . . . is too large, a calculation amount when the combinatorial optimization problem is solved is enormous. Therefore, the processing unit 12 generates a causal relationship candidate with high accuracy as possible.

For example, the processing unit 12 selects at least some of the one or the plurality of first questions and one of the one or the plurality of second questions and selects one first answer candidate for each of the selected first questions. Furthermore, the processing unit 12 selects the second answer candidate to the selected second question (for example, answer of most respondents) on the basis of the answer to the second question selected by the respondent whose answer is the same as the selected first answer candidate. Then, the processing unit 12 generates a causal relationship candidate including the selected first answer candidate and the selected second answer candidate.

As a result, it is possible to reduce the number of causal relationship candidates 1a, 1b, . . . without lowering the accuracy of the combination of the causal relationship candidates included in the solution of the combinatorial optimization problem. The number of causal relationship candidates 1a, 1b, . . . is smaller so that a time for searching for the solution of the combinatorial optimization problem is shortened.

### Second Embodiment

Next, a second embodiment will be described. In the second embodiment, a causal relationship between an attribute and a food waste behavior of a respondent to a questionnaire is analyzed by a computer using questionnaire survey results.

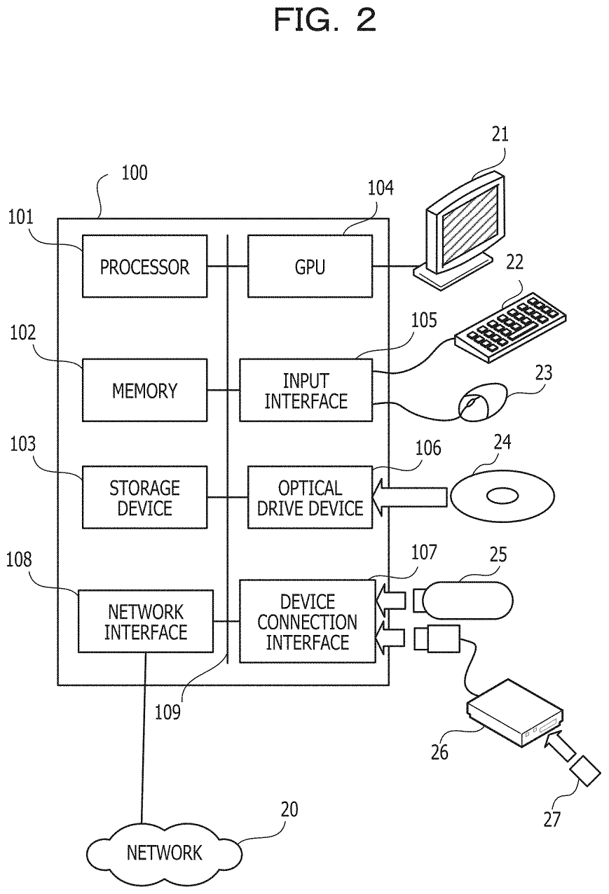

FIG. 2 is a diagram illustrating an example of hardware of a computer. An entire device of a computer 100 is controlled by a processor 101. A memory 102 and a plurality of peripheral devices are coupled to the processor 101 via a bus 109. The processor 101 may be a multiprocessor. The processor 101 is, for example, a central processing unit (CPU), a micro processing unit (MPU), or a digital signal processor (DSP). At least some of functions implemented by the processor 101 by executing a program may be implemented by an electronic circuit such as an application specific integrated circuit (ASIC), a programmable logic device (PLD), or the like.

The memory 102 is used as a main storage device of the computer 100. The memory 102 temporarily stores at least some of operating system (OS) programs and application programs to be executed by the processor 101. Furthermore, the memory 102 stores various types of data to be used for processing by the processor 101. As the memory 102, for example, a volatile semiconductor storage device such as a random access memory (RAM) is used.

Examples of the peripheral devices coupled to the bus 109 include a storage device 103, a graphics processing unit (GPU) 104, an input interface 105, an optical drive device 106, a device connection interface 107, and a network interface 108.

The storage device 103 electrically or magnetically performs data writing/reading on a built-in recording medium. The storage device 103 is used as an auxiliary storage device of the computer 100. The storage device 103 stores OS programs, application programs, and various types of data. Note that, as the storage device 103, for example, a hard disk drive (HDD) or a solid state drive (SSD) may be used.

The GPU 104 is an arithmetic device that executes image processing, and is also called a graphic controller. A monitor 21 is coupled to the GPU 104. The GPU 104 causes an image to be displayed on a screen of the monitor 21 in accordance with an instruction from the processor 101. Examples of the monitor 21 include a display device using organic electro luminescence (EL), a liquid crystal display device, and the like.

A keyboard 22 and a mouse 23 are coupled to the input interface 105. The input interface 105 transmits signals transmitted from the keyboard 22 and the mouse 23 to the processor 101. Note that the mouse 23 is an example of a pointing device, and another pointing device may be used. Examples of the another pointing device include a touch panel, a tablet, a touch pad, a track ball, and the like.

The optical drive device 106 uses laser light or the like to read data recorded in an optical disk 24 or write data to the optical disk 24. The optical disk 24 is a portable recording medium in which data is recorded to be readable by reflection of light. Examples of the optical disk 24 include a digital versatile disc (DVD), a DVD-RAM, a compact disc read only memory (CD-ROM), a CD-recordable (R)/rewritable (RW), and the like.

The device connection interface 107 is a communication interface for connecting the peripheral devices to the computer 100. For example, a memory device 25 and a memory reader/writer 26 may be connected to the device connection interface 107. The memory device 25 is a recording medium mounting a communication function with the device connection interface 107. The memory reader/writer 26 is a device that writes data into a memory card 27 or reads data from the memory card 27. The memory card 27 is a card-type recording medium.

The network interface 108 is coupled to a network 20. The network interface 108 exchanges data with another computer or communication device via the network 20. The network interface 108 is a wired communication interface coupled to a wired communication device such as a switch, a router, or the like with a cable, for example. Furthermore, the network interface 108 may be a wireless communication interface that is coupled to and communicates with a wireless communication device such as a base station, an access point, or the like with radio waves.

The computer 100 may implement a processing function of the second embodiment with the hardware as described above. Note that the device described in the first embodiment may be implemented by hardware similar to that of the computer 100 illustrated in FIG. 2.

The computer 100 implements the processing function of the second embodiment by executing, for example, a program recorded on a computer-readable recording medium. A program in which processing content to be executed by the computer 100 is described may be recorded in various recording media. For example, the program to be executed by the computer 100 may be stored in the storage device 103. The processor 101 loads at least some of the programs in the storage device 103 into the memory 102 and executes the program. Furthermore, it is also possible to record the program to be executed by the computer 100 on a portable recording medium such as the optical disk 24, the memory device 25, and the memory card 27. The program stored in the portable recording medium may be executed after being installed in the storage device 103 under the control of the processor 101, for example. Furthermore, the processor 101 may read the program directly from the portable recording medium and execute the program.

With such a computer 100, it is possible to perform data analysis using a questionnaire result.

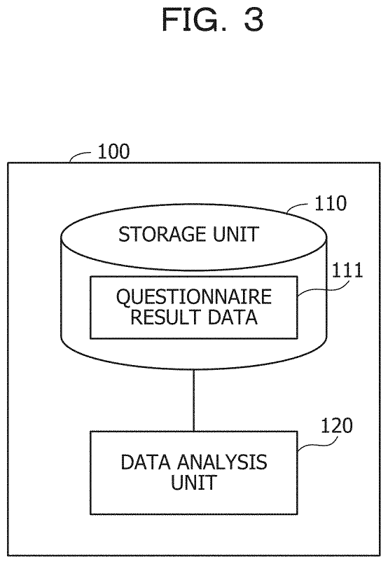

FIG. 3 is a diagram illustrating functions of a computer for data analysis. The computer 100 includes a storage unit 110 and a data analysis unit 120. The storage unit 110 stores questionnaire result data 111. The questionnaire result data 111 is data indicating answers to a plurality of questions included in a questionnaire for each respondent who has answered a questionnaire survey. The storage unit 110 is implemented, for example, by using a part of a storage region of the memory 102 or the storage device 103.

The data analysis unit 120 analyzes a causal relationship between an attribute and a food waste behavior of a respondent on the basis of the questionnaire result data 111. For example, the data analysis unit 120 prepares a plurality of candidates of the causal relationship between the attribute and the food waste behavior of the respondent to the questionnaire. Then, the data analysis unit 120 calculates and outputs combinations of causal relationship candidates of which the number is smaller as possible, as accurately as possible, while considering all the respondents. The data analysis unit 120 may solve the combination of the causal relationship candidates obtained by the calculation as a combinatorial optimization problem.

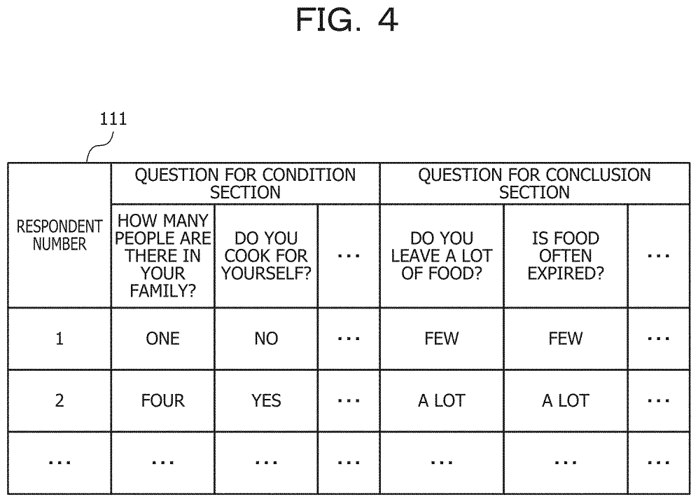

FIG. 4 is a diagram illustrating an example of questionnaire result data. In the questionnaire result data 111, an answer of a respondent to a question included in the questionnaire is set in association with a respondent number used to identify the respondent. The questions are divided into questions for a condition section of the causal relationship candidate and questions for a conclusion section of the causal relationship candidate.

The question for the condition section is a question regarding an attribute of a respondent. For example, “How many people are there in your family?”, “Do you cook for yourself?”, or the like correspond to the question for the condition section. In response to the question “How many people are there in your family?”, the respondent answers the number of people in the family to which the respondent belongs. Furthermore, in response to the question “Do you cook for yourself?”, the respondent answers “Yes” if the respondent has a habit for cooking for oneself and answers “No” if the respondent does not have a habit for cooking for oneself.

The question for the conclusion section is a question regarding a food waste behavior of the respondent. For example, “Do you leave a lot of food?”, “Is food often expired?”, or the like are the questions for the conclusion section. In response to the question “Do you leave a lot of food?”, the respondent answers “a lot” in a case where the respondent leaves many foods and answers “few” in a case where the respondent leaves few food. In response to the question “Is food often expired?”, the respondent answers “a lot” if the purchased food is often not consumed and is expired, and answers “few” if the purchased food is less likely expired without being consumed.

Note that, in the example in FIG. 4, although only a part that changes in the content of the answer such as “one”, “No”, or “few” is indicated as the answer to the question, each answer includes information regarding the corresponding question. For example, like “How many people are there in your family?=one”, “Do you cook for yourself?=No”, and “Do you leave a lot of food?=few”, the information regarding the corresponding question is included in each answer.

Note that the questions for the condition section in the second embodiment are examples of the first question described in the first embodiment. Furthermore, the questions for the conclusion section in the second embodiment are examples of the second question described in the first embodiment.

The questionnaire result data 111 indicating results of a large number of respondents answering the questionnaire is stored in the storage unit 110. Then, the data analysis unit 120 performs data analysis on the basis of the questionnaire result data 111.

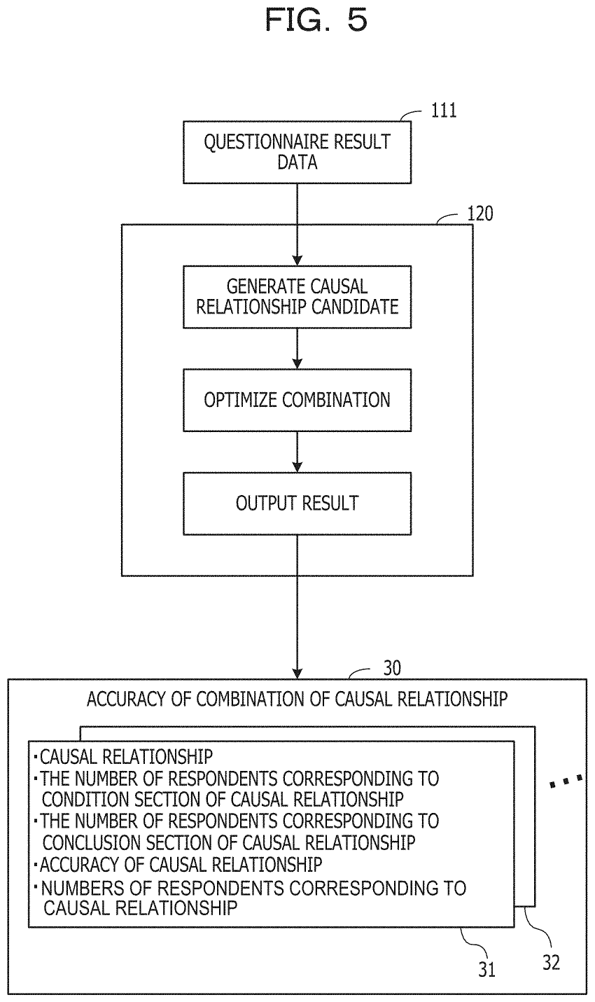

FIG. 5 is a diagram illustrating an example of processing of a data analysis unit. For example, the data analysis unit 120 generates a plurality of causal relationship candidates on the basis of the questionnaire result data 111. The causal relationship candidate includes one or a plurality of questions for the condition section and one question for the conclusion section. The data analysis unit 120 determines a combination of causal relationships that correctly explain all the respondents to the questionnaire result data 111, from among the plurality of causal relationship candidates, with a solution search method using combinatorial optimization. At this time, the data analysis unit 120 sets a constraint condition in combinatorial optimization so as to reduce the number of causal relationships to be combined. Then, the data analysis unit 120 outputs analysis result data 30.

The analysis result data 30 includes a plurality of pieces of causal relationship data 31, 32, . . . indicating a causal relationship that correctly explains the respondent. Each piece of the causal relationship data 31, 32, . . . includes a causal relationship, the number of respondents corresponding to the condition section of the causal relationship, the number of respondents corresponding to the conclusion section of the causal relationship, accuracy of the causal relationship, and numbers of respondents corresponding to the causal relationship.

The analysis result data 30 includes the accuracy of the combination of the causal relationship. The accuracy of the combination of the causal relationship is expressed by the total number of respondents who are not correctly explained by the causal relationship, for example. In this case, a smaller value indicates a more accurate combination of a causal relationship.

For example, the data analysis unit 120 calculates the total number of respondents corresponding to the condition section, for a combination of causal relationship candidates left in an analysis result. Furthermore, the data analysis unit 120 calculates the total number of respondents corresponding to the conclusion section, for a combination of causal relationship candidates left in the analysis result. Then, the data analysis unit 120 calculates the accuracy of the combination of the causal relationship candidates by subtracting the total number of respondents corresponding to the conclusion section from the total number of respondents corresponding to the condition section. A smaller value calculated through subtraction indicates a more accurate combination of causal relationship candidates.

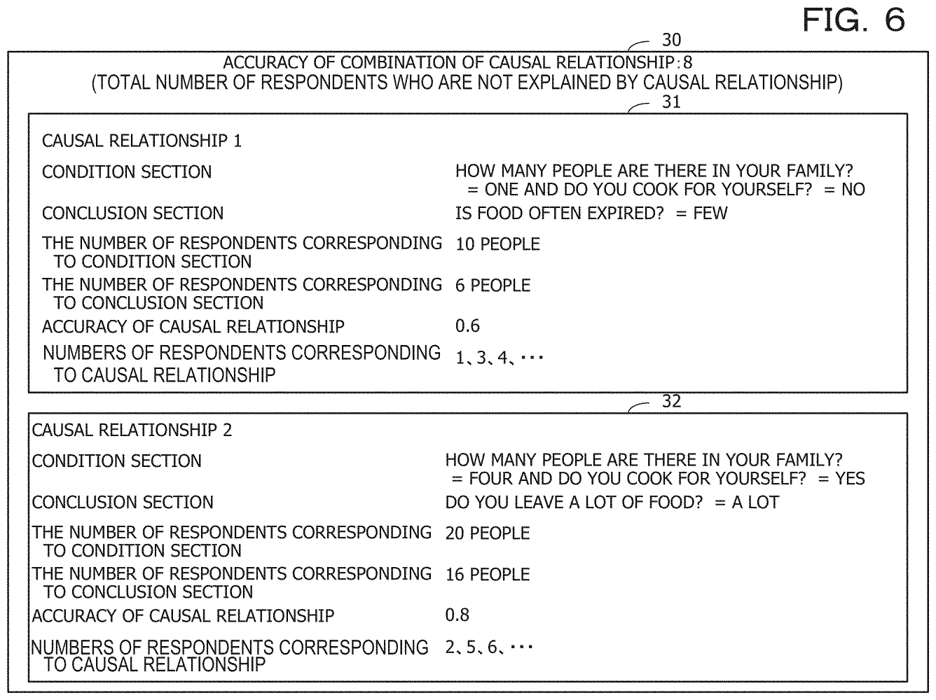

FIG. 6 is a diagram illustrating an example of analysis result data. For example, a condition section of a causal relationship indicated in the causal relationship data 31 is to answer “one” to the question “How many people are there in your family?” and to answer “No” to the question “Do you cook for yourself?”. Furthermore, a conclusion section of the causal relationship indicated in the causal relationship data 31 is to answer “few” to the question “Is food often expired?”.

The number of respondents corresponding to the condition section of the causal relationship data 31 is “10”. Among the respondents corresponding to the condition section of the causal relationship data 31, the number of respondents corresponding to the conclusion section is “6”.

The accuracy of each causal relationship is indicated by a ratio of the respondents corresponding to the conclusion section among the respondents corresponding to the condition section, for example. In a case of the causal relationship data 31, the accuracy of the causal relationship is “0.6”. In this case, the higher numerical value of the accuracy of the causal relationship indicates that the causal relationship is more accurate.

Furthermore, in the causal relationship data 31, respondent numbers of respondents corresponding to the causal relationship are “1, 3, 4, . . . ”.

The causal relationship data 32 indicates the same type of information as the causal relationship data 31. The analysis result data 30 further indicates accuracy of a combination of a causal relationship. In the example in FIG. 6, the number of respondents corresponding to a condition section of a causal relationship 1 is 10, the number of respondents corresponding to a conclusion section is six, the number of respondents corresponding to a condition section of a causal relationship 2 is 20, and the number of respondents corresponding to a conclusion section is 16. Therefore, “accuracy of a combination of causal relationship candidates=10+20−(6+16)=8”. This is a sum of the number of respondents who are not explained by the causal relationship indicated in the causal relationship data 31 and the number of respondents who are not explained by the causal relationship indicated in the causal relationship data 32.

Next, data analysis processing for analyzing the causal relationship between the attribute and the food waste behavior of the respondent to the questionnaire will be described in detail.

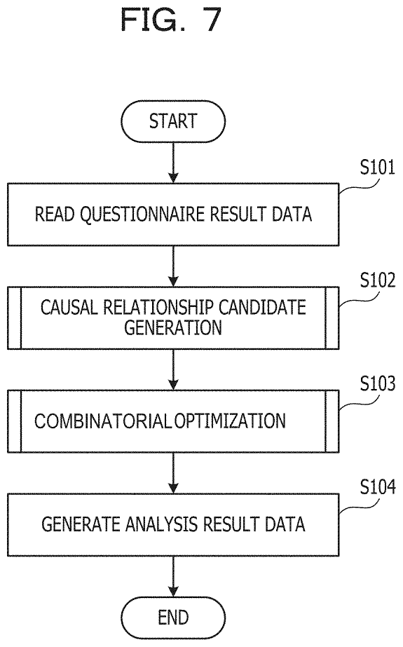

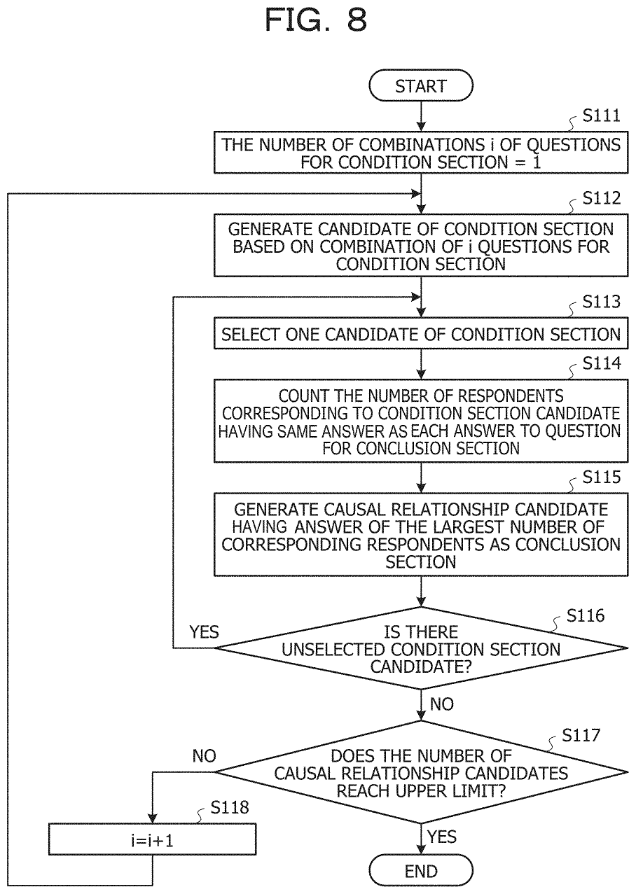

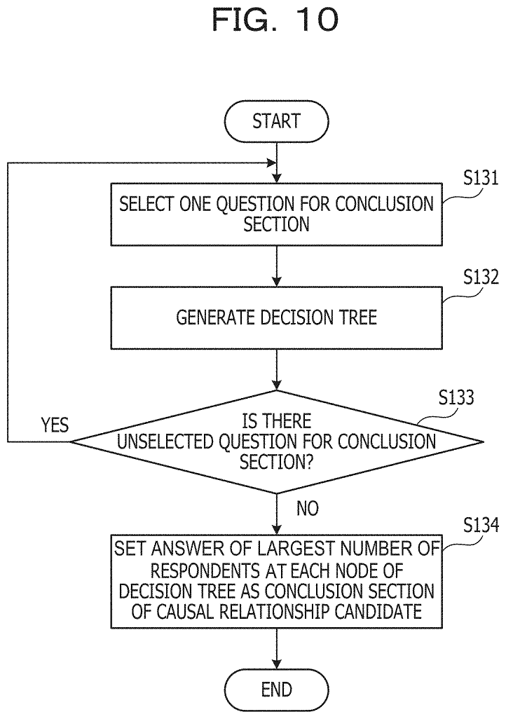

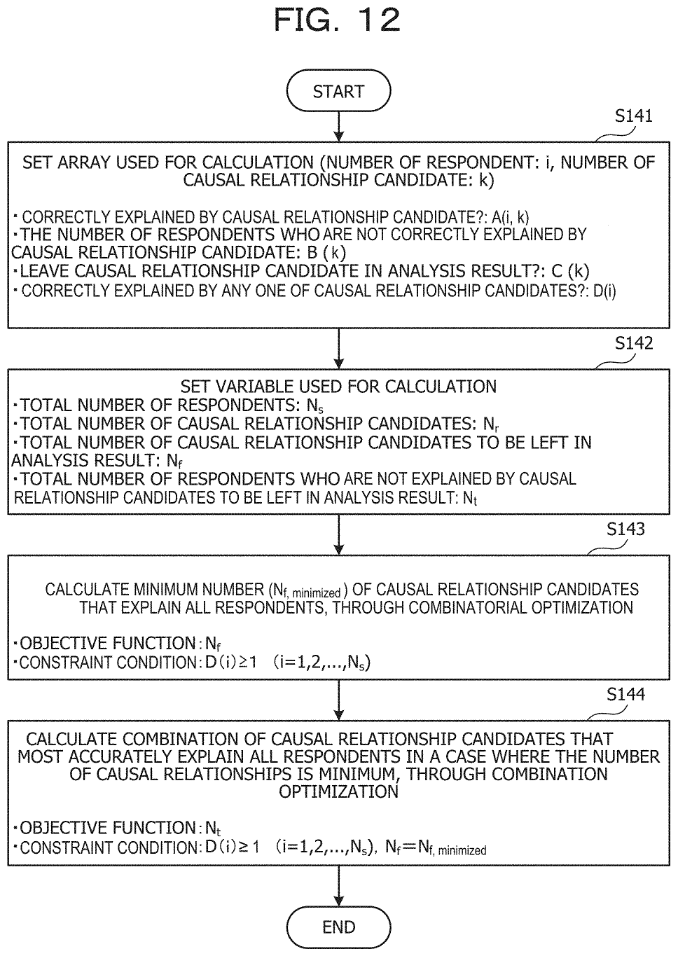

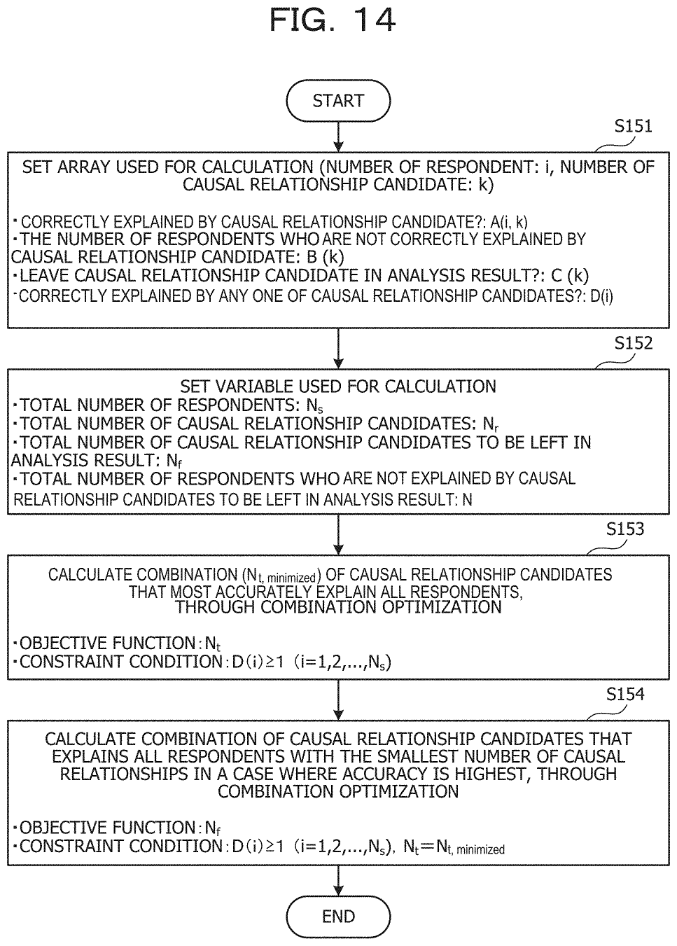

FIG. 7 is a flowchart illustrating an example of a procedure of the data analysis processing. Hereinafter, the processing illustrated in FIG. 7 will be described.

[Step S101] The data analysis unit 120 reads the questionnaire result data 111 from the storage unit 110.

[Step S102] The data analysis unit 120 executes the causal relationship candidate generation processing on the basis of the questionnaire result data 111. Details of the causal relationship candidate generation processing will be described later (refer to FIGS. 8 and 10). Through the causal relationship candidate generation processing, a plurality of causal relationship candidates assuming an answer to each of one or more questions for the condition section of the questionnaire as a condition section and an answer to one question for the conclusion section of the questionnaire as a conclusion section is generated.

[Step S103] The data analysis unit 120 executes the combinatorial optimization processing for determining whether or not to leave each of the plurality of causal relationship candidates in the analysis result of the analysis. Details of the combinatorial optimization processing will be described later (refer to FIGS. 12 and 14).

[Step S104] The data analysis unit 120 generates the analysis result data 30 having the causal relationship candidate that is determined to be left in the analysis result of the analysis by the combinatorial optimization processing as the causal relationship between the attribute and the food waste behavior of the respondent. The attribute of the respondent is indicated in the condition section of the causal relationship. Furthermore, the food waste behavior is indicated in the conclusion section of the causal relationship. The data analysis unit 120 displays content of the generated analysis result data 30, for example, on the monitor 21. Furthermore, the data analysis unit 120 stores the generated analysis result data 30 in the storage device 103.

In this way, the causal relationship between the attribute and the food waste behavior of the respondent is analyzed.

Next, the causal relationship candidate generation processing will be described in detail.

FIG. 8 is a flowchart illustrating a first example of the causal relationship candidate generation processing. Hereinafter, processing illustrated in FIG. 8 will be described.

[Step S111] The data analysis unit 120 initializes the number of combinations i of the questions to be included in the condition section to “1” (i=1).

[Step S112] The data analysis unit 120 generates a candidate of the condition section on the basis of combinations of i questions for the condition section.

For example, in a case of i=1, the data analysis unit 120 generates the candidate of the condition section for each answer to each of the questions for the condition section such as “How many people are there in your family?”, “Do you cook for yourself?”, or the like. For example, for the question “How many people are there in your family?”, the candidates of the condition section are generated for each number of people in the family, such as “How many people are there in your family?=one” and “How many people are there in your family?=two”. Furthermore, for the question “Do you cook for yourself?”, two candidates for the condition section are generated such as “Do you cook for yourself?=Yes” and “Do you cook for yourself?=No”.

In a case of i=2, for a combination of two questions of the condition section, the data analysis unit 120 generates a candidate of the condition section for each combination of the answers to these questions. For example, for the combination of the questions “How many people are there in your family?” and “Do you cook for yourself?”, the data analysis unit 120 generates a candidate of the condition section for each combination of the answers to these questions. For example, the candidates of the condition section are generated such as “How many people are there in your family?=one AND Do you cook for yourself?=Yes”, “How many people are there in your family?=one AND Do you cook for yourself?=No”, “How many people are there in your family?=two AND Do you cook for yourself?=Yes”, or “How many people are there in your family?=two AND Do you cook for yourself?=No”.

Similarly, in a case where the value of i is equal to or more than three, for a combination of i questions of the condition section, the data analysis unit 120 generates a candidate of the condition section for each combination of answers to these questions.

[Step S113] The data analysis unit 120 selects one unselected candidate of the condition section from among the generated candidates of the condition section.

[Step S114] On the basis of the questionnaire result data 111, the data analysis unit 120 counts the number of respondents with corresponding answers to the question from among the respondents corresponding to the selected candidate of the condition section for each answer to the question for the conclusion section. The respondent corresponding to the selected candidate of the condition section is a respondent whose answer is the same as the candidate of the condition section with respect to the question of the selected candidate of the condition section.

[Step S115] The data analysis unit 120 determines, as the conclusion section, an answer of the largest number of respondents (respondents corresponding to selected candidate for condition section) among the answers to the question for the conclusion section. Then, the data analysis unit 120 generates a causal relationship candidate having the determined conclusion section as the conclusion section of the causal relationship, assuming the selected candidate of the condition section as the condition section of the causal relationship.

[Step S116] The data analysis unit 120 determines whether or not there is an unselected candidate of the condition section. In a case where there is an unselected candidate of the condition section, the data analysis unit 120 proceeds the processing to step S113. If there is no unselected candidate of the condition section, the data analysis unit 120 proceeds the processing to step S117.

[Step S117] The data analysis unit 120 determines whether or not the number of generated causal relationship candidates reaches a predetermined upper limit. In a case where the number of causal relationship candidates reaches the upper limit, the data analysis unit 120 ends the causal relationship candidate generation processing. If the number of causal relationship candidates does not reach the upper limit, the data analysis unit 120 proceeds the processing to step S118.

[Step S118] The data analysis unit 120 increments the number of combinations i of the questions of the condition section only by “1” (i=i+1) and proceeds the processing to step S112.

In this way, while increasing the number of combinations of the questions of the condition section, the data analysis unit 120 repeats to generate causal relationship candidates until the number of causal relationship candidates reaches the upper limit.

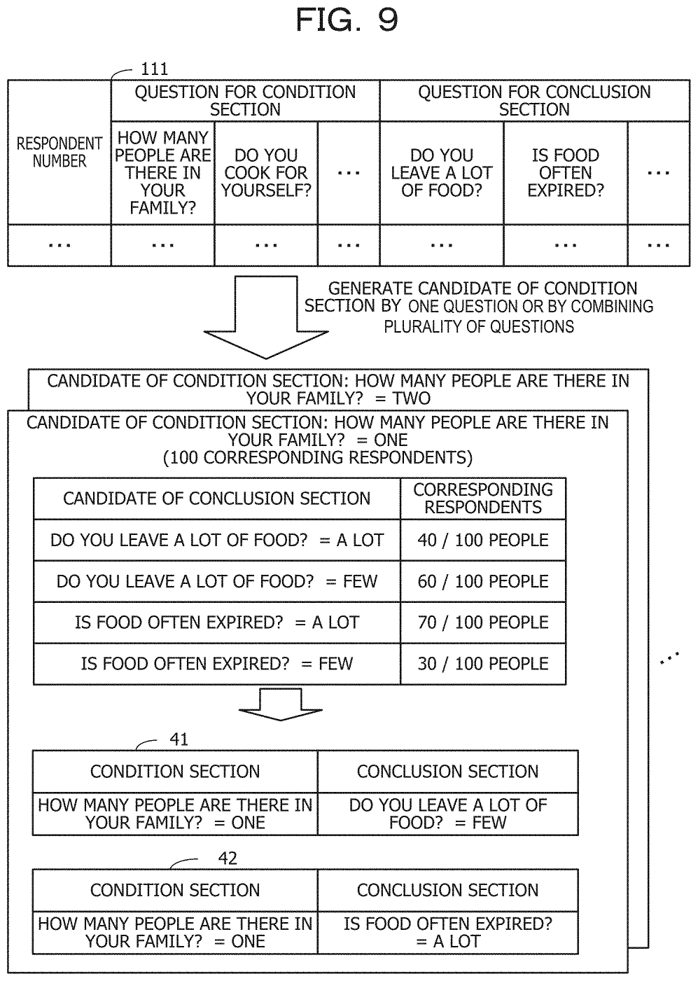

FIG. 9 is a diagram illustrating an example of a generated causal relationship candidate. In the example in FIG. 9, a generation example of a causal relationship candidate in a case where the answer “one” to the question “How many people are there in your family?” is selected as a candidate of the condition section to be processed is illustrated. In the example in FIG. 9, the number of respondents corresponding to the candidate of the condition section (respondent who answers “How many people are there in your family?=one”) is 100.

For the question for the conclusion section “Do you leave a lot of food?”, the data analysis unit 120 generates candidates of the conclusion section (“Do you leave a lot of food?=a lot” and “Do you leave a lot of food?=few”) for each answer to the question. Then, the data analysis unit 120 counts the number of respondents corresponding to the candidate of each conclusion section from among the respondents corresponding to the candidate of the condition section. The data analysis unit 120 determines a candidate with the largest corresponding respondents from among the candidates of the conclusion section, as the conclusion section of the causal relationship candidate. In the example in FIG. 9, the number of respondents who answer “Do you leave a lot of food?=a lot” is 40 out of 100 respondents, and the number of respondents who answer “Do you leave a lot of food?=few” Is 60 out of 100 respondents. Therefore, the data analysis unit 120 generates a causal relationship candidate 41 having the condition section “How many people are there in your family?=one” and the conclusion section “Do you leave a lot of food?=few”.

Furthermore, for the question for the conclusion section “Is food often expired?”, the data analysis unit 120 generates candidates of the conclusion section (“Is food often expired?=a lot” and “Is food often expired?=few”) for each answer to the question. In the example in FIG. 9, the number of respondents who answer “Is food often expired?=a lot” is 70 out of 100 respondents, and the number of respondents who answer “Is food often expired?=few” is 30 out of 100 respondents. Therefore, the data analysis unit 120 generates a causal relationship candidate 42 having the condition section “How many people are there in your family?=one” and the conclusion section “Is food often expired?=a lot”.

Such generation of the causal relationship candidate is performed for each candidate of the condition section. In a case where the number of combinations of the questions of the condition section is two, a combination of the two questions for the condition section is a candidate of the condition section. For example, it is assumed that the number of respondents corresponding to the candidate of the condition section “How many people are there in your family?=four AND Do you cook for yourself?=Yes” be 40. At this time, for example, it is assumed that the number of respondents corresponding to the candidate of the conclusion section “Is food often expired?=a lot” be 30 and the number of respondents corresponding to the candidate of the conclusion section “Is food often expired?=few” be 10. In this case, the conclusion section of the candidate of the causal relationship of which the condition section is “How many people are there in your family?=four AND Do you cook for yourself?=Yes” Is “Is food often expired?=a lot”.

Note that information set to the condition section of the causal relationship candidate in the second embodiment is an example of the first answer candidate in the first embodiment. Furthermore, information set to the conclusion section of the causal relationship candidate in the second embodiment is an example of the second answer candidate in the first embodiment.

In the examples illustrated in FIGS. 8 and 9, while increasing the number of questions included in the causal relationship candidate, a candidate of the condition section is comprehensively generated for each combination of questions. On the other hand, it is possible to efficiently generate causal relationship candidates using the decision tree analysis.

FIG. 10 is a flowchart illustrating a second example of the causal relationship candidate generation processing. Hereinafter, the processing illustrated in FIG. 10 will be described.

[Step S131] The data analysis unit 120 selects one question for the conclusion section from among unselected questions for the conclusion section.

[Step S132] The data analysis unit 120 generates a decision tree corresponding to the selected question for the conclusion section. A question for the condition section is associated with each node other than leaves of the decision tree. An upper node is connected to a lower node with a branch corresponding to an answer to a question of the upper node. Then, the data analysis unit 120 follows the branch from a root node according to an answer to a question for the condition section, for each respondent. Then, for each node of the decision tree, the data analysis unit 120 sets the number of respondents having each answer to the selected question for the conclusion section, for each answer from among respondents who reach the node.

[Step S133] The data analysis unit 120 determines whether or not there is an unselected question for the conclusion section. If there is an unselected question for the conclusion section, the data analysis unit 120 proceeds the processing to step S131. If there is no unselected question for the conclusion section, the data analysis unit 120 proceeds the processing to step S134.

[Step S134] The data analysis unit 120 generates a causal relationship candidate corresponding to each node of the decision tree other than the root node. A condition section of the generated causal relationship candidate is a logical product of an answer to each of one or more questions for the condition section from the root node to the relevant node of the decision tree. Furthermore, an answer of the largest number of respondents that reach the node is set to the conclusion section of the generated causal relationship candidate, among answers to the question for the conclusion section corresponding to the decision tree.

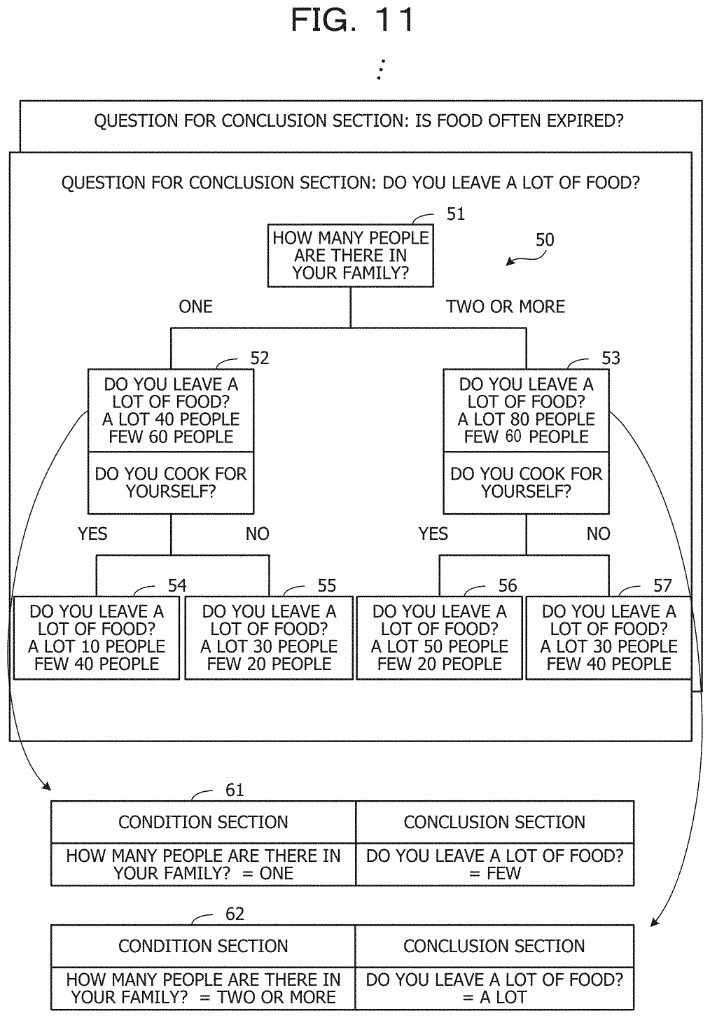

FIG. 11 is a diagram illustrating a generation example of a causal relationship candidate using the decision tree analysis. In FIG. 11, a decision tree 50 corresponding to the question for the conclusion section “Do you leave a lot of food?” is illustrated. Note that the decision tree 50 is an example in a case where the questions for the condition section are two questions “How many people are there in your family?” and “Do you cook for yourself?”. A node 51 that is a root node of the decision tree 50 is associated with the question for the condition section “How many people are there in your family?”. Nodes 52 and 53 lower than the node 51 are associated with the question for the condition section “Do you cook for yourself?”. A branch from the node 51 to the node 52 is associated with an answer “one” to “How many people are there in your family?”. A branch from the node 51 to the node 53 is associated with an answer “two or more” (including answers of two, three, . . . ) to “How many people are there in your family?”.

To each of nodes 52 to 57 other than the root node, the number of respondents, among the respondents who reach the node”, for each answer to the question for the conclusion section “Do you leave a lot of food?” is set. For example, the respondent who reaches the node 52 is a respondent who answers “one” to the question for the condition section “How many people are there in your family?”. In the example in FIG. 11, 100 respondents exist who reach the node 52. Of these, for the question for the conclusion section “Do you leave a lot of food?”, the number of respondents who answer “a lot” is 40, and the number of respondents who answer “few” is 60.

The data analysis unit 120 generates a causal relationship candidate corresponding to each of the nodes 52 to 57 other than the root node. To the condition section of the generated causal relationship candidate, a common answer to the question for the condition section by the respondent who reaches the corresponding node is set. Furthermore, to the conclusion section of the causal relationship candidate, the most common answer by the respondents who reach the respective nodes 52 to 57 to the question for the conclusion section “Do you leave a lot of food?” corresponding to the decision tree 50 is set.

For example, to a condition section of a causal relationship candidate 61 corresponding to the node 52, “How many people are there in your family?=one” is set. Sixty respondents out of 100 respondents who reach the node 52 answer “few” to the question for the conclusion section “Do you leave a lot of food?”. Therefore, to a conclusion section of the causal relationship candidate 61, “Do you leave a lot of food?=few” is set.

Furthermore, to a condition section of a causal relationship candidate 62 corresponding to the node 53, “How many people are there in your family?=two or more” is set. Eighty respondents of 140 respondents who reach the node 53 answer “a lot” to the question for the conclusion section “Do you leave a lot of food?”. Therefore, to a conclusion section of the causal relationship candidate 62, “Do you leave a lot of food?=a lot” is set.

Similarly, causal relationship candidates corresponding to other nodes 54 to 57 of the decision tree 50 are generated. For example, the causal relationship candidate corresponding to the node 54 includes a condition section “How many people are there in your family?=one AND Do you cook for yourself?=Yes” (the number of respondents: 50) and a conclusion section “Do you leave a lot of food?=few” (the number of respondents: 40). The causal relationship candidate corresponding to the node 55 includes a condition section “How many people are there in your family?=one AND Do you cook for yourself?=No” (the number of respondents: 50) and a conclusion section “Do you leave a lot of food?=a lot” (the number of respondents: 30). The causal relationship candidate corresponding to the node 56 includes a condition section “How many people are there in your family?=two or more AND Do you cook for yourself?=Yes” (the number of respondents: 70) and a conclusion section “Do you leave a lot of food?=a lot” (the number of respondents: 50). The causal relationship candidate corresponding to the node 57 includes a condition section “How many people are there in your family?=two or more AND Do you cook for yourself?=No” (the number of respondents: 70) and a conclusion section “Do you leave a lot of food?=few” (the number of respondents: 40).

Moreover, a corresponding causal relationship candidate is generated for the node of the decision tree generated in correspondence with another question for the conclusion section (for example, “Is food often expired?”).

When the causal relationship candidate is generated, the data analysis unit 120 calculates a combination of causal relationship candidates that accurately explain all the respondents with few causal relationships as possible, using the combinatorial optimization method. To optimize the combination of the causal relationship candidates, processing differs according to whether or not to prioritize the smaller number of causal relationships or to prioritize accuracy of the causal relationship.

FIG. 12 is a flowchart illustrating an example of a procedure of combinatorial optimization processing that prioritizes the smaller number of causal relationships. Hereinafter, the processing illustrated in FIG. 12 will be described.

[Step S141] The data analysis unit 120 sets an array “A (i, k), 8 (k), C (k), D (i)” used for combinatorial optimization calculation. The reference i is a respondent number. The reference k is a number of a causal relationship candidate.

The array A (i, k) is an array indicating a respondent who is correctly explained by the causal relationship candidate. The data analysis unit 120 sets “1” to the value of A (i, k) in a case where an i-th respondent is correctly explained by a k-th causal relationship candidate. Furthermore, the data analysis unit 120 sets “0” to the value of A (i, k) in a case where the i-th respondent is not correctly explained by the k-th causal relationship candidate.

The array B (k) is an array indicating the number of respondents who are not correctly explained by the causal relationship candidate. For example, the data analysis unit 120 sets the number of respondents who correspond to the condition section of the k-th causal relationship candidate and do not correspond to the conclusion section to B(k) as the number of respondents who are not correctly explained by the causal relationship candidate.

The array C (k) is an array indicating a causal relationship candidate to be left in the analysis result. The data analysis unit 120 set “1” to C (k) in a case where the k-th causal relationship candidate is left in the analysis result and sets “0” to C (k) in a case where the k-th causal relationship candidate is not left in the analysis result.

The array D (i) is an array indicating whether or not the respondent is correctly explained by any one of the causal relationship candidates to be left in the analysis result. The data analysis unit 120 sets D (i)≥1 in a case where an i-th respondent is correctly explained by at least one of the causal relationship candidates to be left in the analysis result. For example, D (i) is expressed by the following formula.

$$D ( i ) = {\sum }_{k = 1}^{{N}_{r}} A ( i , k ) \times C ( k ) \qquad ( 1 )$$

[Step S142] The data analysis unit 120 sets variables “Nₛ, Nᵣ, N_{f}, Nₜ” used for the combinatorial optimization calculation. The variable Nₛ is a variable indicates the total number of respondents. The data analysis unit 120 sets Nₛ to the total number of respondents indicated in the questionnaire result data 111. The variable Nᵣ is the total number of causal relationship candidates. The data analysis unit 120 sets Nᵣ to the total number of causal relationship candidates generated through the causal relationship candidate generation processing. The variable N_{f} is the total number of causal relationship candidates to be left in the analysis result. A value of N_{f} is expressed the following formula.

$${N}_{f} = {\sum }_{k = 1}^{{N}_{r}} C ( k ) \qquad ( 2 )$$

The variable Nₜ is a variable indicating the total number of respondents who are not explained by the causal relationship candidates to be left in the analysis result. A value of Nₜ is expressed by the following formula.

$${N}_{r} = {\sum }_{k = 1}^{{N}_{r}} B ( k ) \times C ( k ) \qquad ( 3 )$$

[Step S143] The data analysis unit 120 calculates, through combinatorial optimization, the minimum number (N_{f,minimized}) of the causal relationship candidates that explain all the respondents. An objective function to be minimized in the combinatorial optimization problem at this time is N_{f} indicated in the formula (2). Furthermore, a constraint condition is “D (i)≥1” (i=1, 2, . . . , Nₛ).

[Step S144] The data analysis unit 120 calculates, through combinatorial optimization, a combination of causal relationship candidates that most accurately explain all the respondents in a case where the number of causal relationships is the minimum. An objective function to be minimized in the combinatorial optimization problem at this time is Nₜ indicated in the formula (3). Furthermore, constraint conditions are “D (i)≥1” (I=1, 2, . . . , Nₛ) and “N_{f}=N_{f,minimized}”. The causal relationship candidate to be “C (k)=1” as a result of this combinatorial optimization calculation is a causal relationship to be output as an analysis result.

In this way, a combination that most accurately expresses the causal relationship may be assumed as the analysis result, from among the combinations of the minimum causal relationship candidates that correctly explain all the respondents.

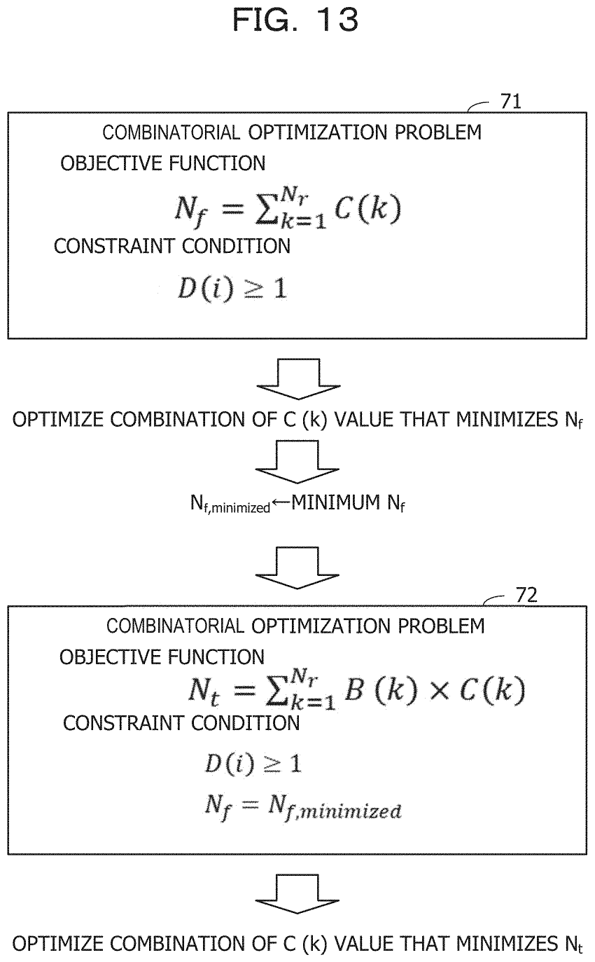

FIG. 13 is a diagram illustrating a procedure for determining a causal relationship candidate to be left in an analysis result of the combinatorial optimization processing that prioritizes the smaller number of causal relationships. As illustrated in FIG. 13, in a combinatorial optimization problem 71 in a first stage, under a constraint condition “D (i)≥1” for all the respondents (i=1, 2, . . . , Nₛ), a combination of causal relationship candidates to minimize the total number Nₜ of the causal relationship candidates to be left in the analysis result is calculated. The constraint condition “D (i)≥1” ensures that all the respondents are correctly explained. By solving this combinatorial optimization problem 71, the minimum number (N_{f,minimized}) of the causal relationship candidates that explain all the respondents is obtained.

In a combinatorial optimization problem 72 in a second stage, a combination of causal relationship candidates is obtained that minimizes Nₜ under a constraint condition such that the minimum number (N_{f,minimized}) of the causal relationship candidates is assumed as the total number Nₜ of the causal relationship candidates to be left in the analysis result. In this case, the constraint condition such that “D (i)≥1” is satisfied for the respondents (i=1, 2, . . . , Nₛ) is set, and it is ensured that all the respondents are correctly explained by the causal relationship candidates to be left in the analysis result.

By solving the combinatorial optimization problem 72 under the constraint condition “N_{f}=N_{f,minimized}” in this way, only a combination pattern obtained by combining the minimum number of causal relationship candidates that correctly explain all the respondents may be a solution of the combinatorial optimization problem 72. In a case where there is the plurality of combination patterns, a combination pattern, among these combination patterns, obtained by combining the causal relationship candidates that most accurately express the causal relationship is obtained as a solution.

FIG. 14 is a flowchart illustrating an example of a procedure of combinatorial optimization processing that prioritizes accuracy of a causal relationship. Processing in steps S151 and S152 illustrated in FIG. 14 is similar to the processing in respective steps S141 and S142 illustrated in FIG. 12. Hereinafter, processing in steps S153 and S154 different from the processing in FIG. 12 will be described.

[Step S153] The data analysis unit 120 calculates, through combinatorial optimization, a combination (N_{t,minimized}) of causal relationship candidates that most accurately explains all the respondents. An objective function to be minimized in the combinatorial optimization problem at this time is Nₜ indicated in the formula (3). Furthermore, a constraint condition is “D (i)≥1” (i=1, 2, . . . , Nₛ).

[Step S154] The data analysis unit 120 calculates, through combinatorial optimization, a combination of causal relationship candidates that explains all the respondents with the smallest number of causal relationships in a case where the accuracy is the highest. An objective function to be minimized in the combinatorial optimization problem at this time is N_{f} indicated in the formula (2). Furthermore, the constraint conditions are “D (i)≥1” (i=1, 2, . . . , Nₛ) and “Nₜ=N_{t,minimized}”. The causal relationship candidate to be “C (k)=1” as a result of this combinatorial optimization calculation is a causal relationship to be output as an analysis result.

In this way, a combination of the minimum number of causal relationship candidates that correctly explain all the respondents among the combinations of the causal relationship candidates that most accurately express the causal relationship may be assumed as the analysis result.

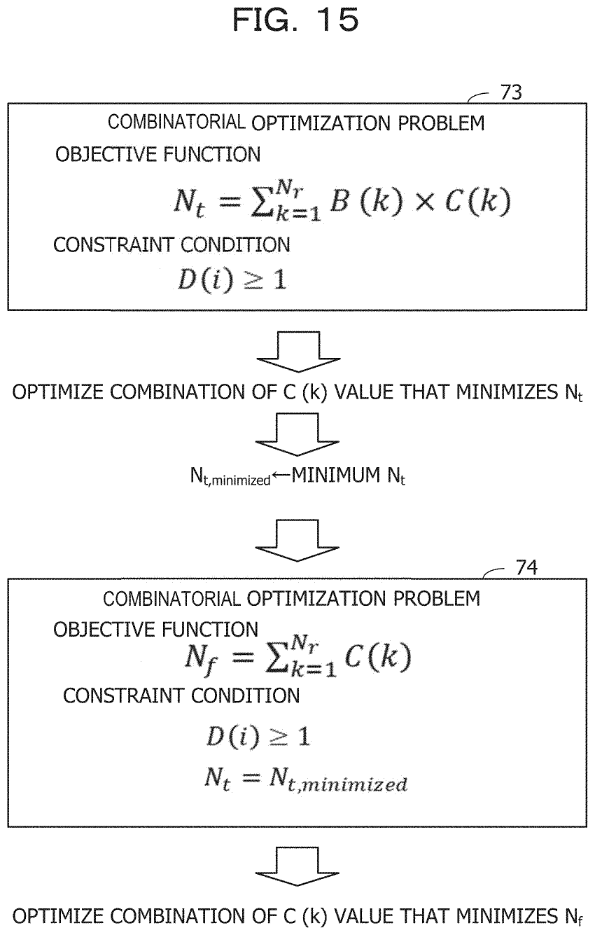

FIG. 15 is a diagram illustrating a procedure for determining a causal relationship candidate to be left in an analysis result of the combinatorial optimization processing that prioritizes the accuracy of the causal relationship. As illustrated in FIG. 15, in a combinatorial optimization problem 73 in a first stage, a constraint condition is imposed such that all respondents (i=1, 2, . . . , Nₛ) satisfy “D (i)≥1”. Under this constraint condition, the combination of the causal relationship candidates that minimizes the total number Nₜ of the respondents that are not accurately explained by the causal relationship candidate to be left in the analysis result is calculated. The constraint condition “D (i)≥1” ensures that all the respondents are correctly explained. By solving this combinatorial optimization problem 73, the minimum value (N_{t,minimized}) of the total number of the respondents that are not accurately explained, in the combination of the causal relationship candidates that explain all the respondents is obtained.

In a combinatorial optimization problem 74 in the second stage, a combination of causal relationship candidates that minimizes N_{f} under a constraint condition such that the minimum value (N_{t,minimized}) of the total number of the respondents who are not accurately explained is assumed as the total number Nₜ of the causal relationship candidates to be left in the analysis result is obtained. In this case, the constraint condition such that “D (i)≥1” is satisfied for the respondents (i=1, 2, . . . , Nₛ) is set, and it is ensured that all the respondents are correctly explained by the causal relationship candidates to be left in the analysis result.

By solving the combinatorial optimization problem 74 under the constraint condition “Nₜ=N_{t,minimized}” in this way, only the combination pattern of the combination of the causal relationship candidates to be the most accurate may be a solution of the combinatorial optimization problem 74. In a case where there is the plurality of combination patterns, a combination pattern, among these combination patterns, of the combination having the smallest total number of causal relationships is obtained as a solution.

Each of one or plurality of causal relationships obtained as the solution may be considered to express a group of respondents that are explained by the causal relationship. Therefore, grouping is performed through processing for generating the causal relationship candidates. The data analysis unit 120 determines the causal relationship to be the analysis result from among the plurality of causal relationship candidates indicating the group, and consistency of grouping is maintained.

Furthermore, in the combinatorial optimization problem, the constraint condition “D (i)≥1” ensures that each respondent is included in any one of groups (respondent group that are explained by causal relationship included in analysis result). Note that there is a plurality of causal relationship candidates that explain one respondent. Therefore, one respondent is allowed to belong to a plurality of groups.

Moreover, the analysis result data 30 indicates accuracy of the combination of the causal relationships, in addition to the accuracy of each causal relationship. The accuracy of the combination of the causal relationship is expressed, for example, by the total number of respondents who are not explained by each causal relationship candidate to be left in the analysis result. In this case, as the number of causal relationship candidates to be left in the analysis result increases, the value of the accuracy of the combination of the causal relationships increases. For example, the accuracy of the combination of the causal relationship reflects accuracy of each causal relationship and the small number of causal relationship candidates to be left in the analysis result. This makes it possible to comprehensively evaluate the accuracy of the causal relationship and the small number of groups to be generated (same as the number of causal relationship candidates to be left in analysis result).

### Other Embodiments

In the second embodiment, the causal relationship between the attribute and the food waste behavior of the questionnaire respondent is analyzed. However, the data analysis processing indicated in the second embodiment is applicable to various types of analysis other than the food waste behavior.

Furthermore, although the respondent is included in any one of groups in the second embodiment, it may be allowed that a certain percentage of respondents are not included in any one of the groups. In that case, instead of the constraint condition that “D (i)≥1” is satisfied for all i's, a constraint condition is used such that “D (i)≥1” is satisfied for a predetermined ratio of or more (for example, equal to or more than 90%) i.

Note that, by converting the combinatorial optimization problem into an Ising model, a combinatorial optimization problem may be solved by an Ising machine. The Ising machine is a computer that specializes in an optimization problem of an Ising model that is one of magnetic models of physics. By using the Ising machine, search for a solution of a combinatorial optimization problem may be efficiently performed. The Ising machine includes a quantum annealing machine using superconducting quantum bits, a coherent Ising machine using light characteristics as artificial spins, a machine that solves a combinatorial optimization problem with a digital circuit inspired by quantum phenomena.

The embodiments have been exemplified above, and the configuration of each unit described in the embodiments may be replaced with another configuration having a similar function. Furthermore, any other components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
generating a plurality of causal relationship candidates each including a pair of a first answer candidate to each of at least some of one or a plurality of first questions and a second answer candidate to one of one or a plurality of second questions based on questionnaire result data that indicates an answer of each of a plurality of respondents to a questionnaire that includes the one or the plurality of first questions regarding an attribute of a relevant respondent and the one or the plurality of second questions regarding a behavior of the relevant respondent; and
searching for a solution of a combinatorial optimization problem that minimizes or maximizes a value of an objective function of which the value changes according to causal relationship candidates to be combined, under a constraint condition such that a predetermined ratio of respondents or more of the plurality of respondents have answers that are same as the pair of the first answer candidate and the second answer candidate of any one of the causal relationship candidates to be combined based on the questionnaire result data.

2. The non-transitory computer-readable recording medium according to claim 1, wherein
the solution of the combinatorial optimization problem minimizes a number of the causal relationship candidates to be combined.

3. The non-transitory computer-readable recording medium according to claim 1, wherein
the solution of the combinatorial optimization problem maximizes accuracy that an attribute indicated by the first answer candidate and a behavior indicated by the second answer candidate have a causal relationship for each of the causal relationship candidates to be combined.

4. The non-transitory computer-readable recording medium according to claim 1, the process further comprising:
searching for a solution of a first combinatorial optimization problem that minimizes a number of the causal relationship candidates to be combined; and
searching for a solution of a second combinatorial optimization problem that maximizes accuracy that an attribute indicated by the first answer candidate and a behavior indicated by the second answer candidate have a causal relationship for each of the causal relationship candidates to be combined, under a constraint condition such that a number of the causal relationship candidates to be combined is equal to the number of the causal relationship candidates included in a combination obtained as the solution of the first combinatorial optimization problem.

5. The non-transitory computer-readable recording medium according to claim 1, the process further comprising:
searching for a solution of a second combinatorial optimization problem that maximizes accuracy that an attribute indicated by the first answer candidate and a behavior indicated by the second answer candidate have a causal relationship for each of the causal relationship candidates to be combined; and
searching for a solution of a first combinatorial optimization problem that minimizes a number of the causal relationship candidates to be combined, under a constraint condition such that accuracy that an attribute and a behavior indicated by each of the causal relationship candidates to be combined have a causal relationship is equal to accuracy that the attribute and the behavior indicated by each of the causal relationship candidates included in a combination obtained as the solution of the second combinatorial optimization problem have a causal relationship.

6. The non-transitory computer-readable recording medium according to claim 3, the process further comprising:
obtaining, for each of the causal relationship candidates to be combined, a subtraction value by subtracting, from a number of first respondents whose answers are same as the first answer candidate indicated by a relevant causal relationship candidate, a number of second respondents whose answers are same as the second answer candidate indicated by the relevant causal relationship candidate among the first respondents; and
maximizing accuracy of having a causal relationship by minimizing a value obtained by adding subtraction values of the respective causal relationship candidates to be combined.

7. The non-transitory computer-readable recording medium according to claim 1, the process further comprising:
selecting the first answer candidate to each of at least some first questions of the one or the plurality of first questions;
selecting one of the one or the plurality of second questions;
selecting the second answer candidate to the selected second question based on answers to the selected second question by respondents whose answers are same as the selected first answer candidate; and
generating the causal relationship candidate that includes the selected first answer candidate and the selected second answer candidate.

8. A questionnaire data analysis method, comprising:
generating, by a computer, a plurality of causal relationship candidates each including a pair of a first answer candidate to each of at least some of one or a plurality of first questions and a second answer candidate to one of one or a plurality of second questions based on questionnaire result data that indicates an answer of each of a plurality of respondents to a questionnaire that includes the one or the plurality of first questions regarding an attribute of a relevant respondent and the one or the plurality of second questions regarding a behavior of the relevant respondent; and
searching for a solution of a combinatorial optimization problem that minimizes or maximizes a value of an objective function of which the value changes according to causal relationship candidates to be combined, under a constraint condition such that a predetermined ratio of respondents or more of the plurality of respondents have answers that are same as the pair of the first answer candidate and the second answer candidate of any one of the causal relationship candidates to be combined based on the questionnaire result data.

9. An information processing apparatus, comprising:
a memory; and
a processor coupled to the memory and the processor configured to:
generate a plurality of causal relationship candidates each including a pair of a first answer candidate to each of at least some of one or a plurality of first questions and a second answer candidate to one of one or a plurality of second questions based on questionnaire result data that indicates an answer of each of a plurality of respondents to a questionnaire that includes the one or the plurality of first questions regarding an attribute of a relevant respondent and the one or the plurality of second questions regarding a behavior of the relevant respondent; and
search for a solution of a combinatorial optimization problem that minimizes or maximizes a value of an objective function of which the value changes according to causal relationship candidates to be combined, under a constraint condition such that a predetermined ratio of respondents or more of the plurality of respondents have answers that are same as the pair of the first answer candidate and the second answer candidate of any one of the causal relationship candidates to be combined based on the questionnaire result data.
